(19) United States
(12) Patent Application Publication
(10) Pub. No.: US 2010/0279064 A1
(43) Pub. Date: Nov. 4, 2010

(54) FLEXIBLE MARKING SYSTEMS WITH PAINTED IMAGES AND METHODS OF MAKING AND USING THEREOF

(76) Inventor: Barry PACEY, Crossgates, Leeds (UK)

Correspondence Address: GARDNER GROFF GREENWALD & VILLANUEVA. PC, 2018 POWERS FERRY ROAD, SUITE 800, ATLANTA, GA, 30339, US

(21) Appl. No.: 12/810,675

(22) PCT Filed: Dec. 30, 2008
(86) PCT No.: PCT/IB08/03986

§ 371 Date: Jun. 25, 2010

Related U.S. Application Data
(60) Provisional application No. 61/017,946, filed on Dec. 31, 2007.

(51) Int. Cl. B32B 3/10; B32B 7/12; B32B 38/00

(52) U.S. Cl. 428/137; 428/354; 156/280

(57) ABSTRACT

Described herein are flexible marking systems possessing one or more painted images. The systems comprise a carrier layer adjacent to the adhesive layer, where the carrier layer is capable of receiving paint to produce painted images. The systems described herein are durable with respect to retaining the painted image. The systems are also durable with respect to remaining on the substrate once applied to the substrate. The systems do not require the use of heat and other expensive equipment for applying the system to the substrate.

### CROSS REFERENCE TO RELATED APPLICATIONS

This application claims priority upon U.S. provisional application Ser. No. 61/017,946, filed Dec. 31, 2007. This application is hereby incorporated by reference in its entirety for all of its teachings.

### BACKGROUND

The ability to mark roadways and other concrete or asphalt substrates provides a useful way to convey information and instructions. A number of different techniques are currently in use for affixing markers and indicators to pavement. For example, liquid painted markings can be applied to the road surface with the use of brushes, rollers, or by motorised portable spray machines. Although efficient with respect to the application of the paint to the surface, there are several disadvantages. The thin coating requires time to cure. Moreover, the thin coating does not have a long life expectancy and is, thus, not very durable. At times, additional coats of paint are required to build up durability.

Adhesive tapes are made from semi rigid materials with a pressure sensitive adhesive for sticking to the road surface. This material does not adhere to the surface very well, which permits moisture to penetrate under the marking and weaken the bond between the tape and the road surface. Additionally, once an edge of the tape is loose, the marking is pulled away from the surface by oncoming traffic.

Another approach involves the use of preformed thermoplastic markers. Preformed thermoplastics can be pre-cut into different shapes and sizes. In certain situations, the thermoplastic material is placed on the road surface and heated with a propane torch to melt the material onto the road surface. This relies on the application of complete heat coverage to ensure 100% bonding to the road. If bonding is incomplete, the unbonded material will break up under passing traffic and the marking will fail. Moreover, if the road surface is damp or wet, the heat from the torch causes moisture to be drawn up to the underside of the marking, which can reduce the strength of the adhesive bond.

In other applications, thermoplastic markers can be applied to road surfaces without the use of heat. In these applications, an adhesive is on the underside of the pavement marker protected by a release liner. The release liner is peeled from the adhesive and the marker is pressed directly to a clean pavement surface. If necessary, it is rolled down after application to ensure a good bond to the pavement. However, the marker is generally not very durable.

Thus, what is needed are durable markers that can be easily applied to substrates such as pavement. It is also desirable that the marker is capable of receiving paint for producing a variety of different logos, words, lines, and other useful information. The systems and methods described herein address these needs.

### BRIEF DESCRIPTION OF THE DRAWINGS

The accompanying FIGURE, which is incorporated in and constitute a part of this specification, illustrates one aspect described below.

FIG. 1 shows the side-view of a flexible marking system described herein.

### SUMMARY OF EMBODIMENTS

Described herein are flexible marking systems possessing one or more painted images. The systems comprise a carrier layer adjacent to the adhesive layer, where the carrier layer is capable of receiving paint to produce painted images. The systems described herein are durable with respect to retaining the painted image. The systems are also durable with respect to remaining on the substrate once applied to the substrate. The systems do not require the use of heat and other expensive equipment for applying the system to the substrate.

The advantages of the invention will be set forth in part in the description which follows, and in part will be obvious from the description, or may be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

### DETAILED DESCRIPTION

Before the present compounds, compositions, and/or methods are disclosed and described, it is to be understood that the aspects described below are not limited to specific compounds, synthetic methods, or uses as such may, of course, vary. It is also to be understood that the terminology used herein is for the purpose of describing particular aspects only and is not intended to be limiting.

In this specification and in the claims that follow, reference will be made to a number of terms that shall be defined to have the following meanings:

It must be noted that, as used in the specification and the appended claims, the singular forms “a,” “an” and “the” include plural referents unless the context clearly dictates otherwise. Thus, for example, reference to “a surfactant” includes mixtures of two or more such surfactants, and the like.

Described herein are flexible marking systems that can be adhered to a substrate. In one aspect, the system comprises:
a. an adhesive layer comprising a first surface and a second surface;
b. a carrier layer comprising a first surface and a second surface, wherein the first surface of the carrier layer is adjacent to the second surface of the adhesive layer, and the second surface of the carrier layer can receive one or more painted images; and
c. at least one painted image on the second surface of the carrier layer.
   Each component of the system as well as the methods for making and using the systems will be discussed below.

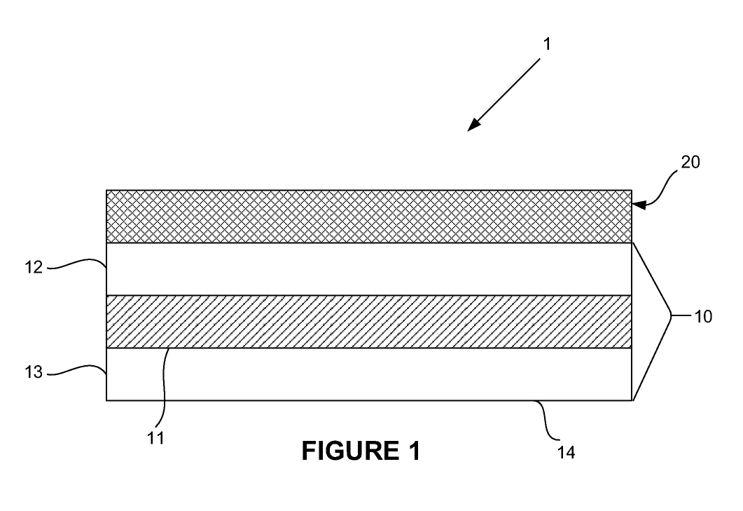

An exemplary system described herein is depicted in FIG. 1. Referring to FIG. 1, system 1 is composed of an adhesive layer 10 and carrier layer 20. The adhesive layer and carrier layer are adjacent to one another (i.e., intimate contact). Methods for applying the carrier layer to the adhesive layer will be described below.

The adhesive layer is generally a pressure sensitive adhesive. The use of heat or solvents is not necessary to secure the adhesive (and the system) to the substrate. Pressure sensitive adhesives are known in the art. For example, acrylics can be used as the adhesive layer. In one aspect, the adhesive layer comprises bitumen. Bitumen includes asphalt, asphaltites, mineral tars, mineral waxes, and polycyclic aromatic hydrocarbons. Bitumen has thermoplastic properties, which is desirable in outdoor applications when there are significant changes in temperature. The bitumen can be modified such that its thermoplastic properties are changed. For example, flux oils or volatile oils can be admixed with the bitumen. Alternatively, synthetic or natural polymers can be added to the bitumen. These polymers can modify certain properties of the bitumen including, but not limited to, softening point and brittleness. In one aspect, the bitumen is modified with styrene butadiene styrene (SBS).

In certain aspects, the adhesive layer further comprises a reinforcing fiber. The reinforcing fiber can be incorporated in the adhesive layer in a number of different ways. In one aspect, referring to FIG. 1, the reinforcing fiber 11 can be sandwiched between two layers of adhesive 12 and 13 (FIG. 1). The reinforcing fiber provides mechanical strength to the system and permits removal of the system from the substrate if needed. Additionally, the reinforcing fiber permits the easy removal of the system from the substrate. For example, the system can be slightly heated while pulling one edge of the system with a gripping tool. This results in the system being removed in one piece without any residual adhesive layer being left on the substrate. The reinforcing fiber can be prepared from woven and nonwoven materials including, but not limited to, polyesters, polyamides, polyalkylenes, or polyvinyl compounds. In one aspect, the reinforcing fiber comprises glass fibers including, but not limited to, glass meshes manufactured by GlasGrid.

The thickness of the adhesive layer is such that there is sufficient adhesive to adhere the carrier layer and to the substrate of interest. In the case when the system is applied to roads and flooring materials, the thickness of the adhesive layer and the system should be as small as possible in order to avoid tripping by pedestrians. In one aspect, the adhesive layer has a thickness less than 40 mils. In one aspect, adhesive materials sold under the tradenames ICE & WATER GUARD and RAINPROOF™ manufactured by Protecto Wrap can be used as the adhesive layer.

As shown in FIG. 1, the carrier layer 20 is adjacent to the adhesive layer 10. In one aspect, the carrier layer is a fibrous material capable of receiving paint. Not wishing to be bound by theory, the carrier layer comprises a matrix that can entrap the paint and other materials. Thus, when the paint is applied to the carrier layer it is not just a mere surface coating. By incorporating paint within the matrix, the durability of the resulting painted image increases. Additionally, the carrier layer provides mechanical strength to the system by keeping the adhesive layer in place. The fibrous material can be composed of a variety of woven fibers including, but not limited to, polyesters, polyamides, polyalkylenes (e.g., polypropylene, polyethylene), and rubber (natural and synthetic). In another aspect, the carrier layer is composed of a woven material or mesh of glass fibers. For example, C20U/2 and C35U/2 fiberglass sold by Owens Corning can be used as the carrier layer. Alternatively, the carrier layer can be a film composed of a polymeric material that can receive the paint. The film can be composed of any of the materials described above. Alternatively, the carrier layer can be pressure sensitive adhesive that is different from the adhesive present in the adhesive layer.

Additional components can be incorporated into the systems described herein. For example, a removable protective layer can be adjacent to the first surface 14 of the adhesive layer. The protective layer can be readily peeled from the adhesive layer when the system is ready to be applied to the substrate of interest. In another aspect, one or more anti-slip materials can be applied to the carrier layer. In one aspect, the anti-slip materials are applied to the carrier layer after the image is painted on the carrier layer. In this aspect, the paint helps adhere and trap the anti-slip materials in the carrier layer matrix. Examples of anti-slip materials useful herein include, but are not limited to, glass, quartz, non-vitreous ceramic, carbide (silicon and boron), aluminum oxides, sandstone, pumice, calcium silicates, aluminum silicofluoride, and aluminum sesquioxide. The size and amount of the anti-slip materials that are used will vary depending upon the selection of the carrier layer and the application of the system.

Methods for making the systems described herein are described below. In one aspect, the method comprises:
a. applying a carrier layer having a first surface and second surface to an adhesive layer, wherein the adhesive layer is adjacent to the first surface of the carrier layer; and
b. painting an image on the second surface of the carrier layer.

With respect to the manufacture of the adhesive layer, the adhesive is fed into a heated trough, which has a number of rollers. In the case when a reinforcing fiber is used, the fiber sheet can be continuously fed into the trough and coated on both sides with the adhesive. Before exiting the trough, the coated fiber sheet passes through two squeeze rollers to set the thickness of the adhesive layer. These squeeze rollers are protected by a film of polyethylene, polypropylene, silicon paper or the like, which not only stop the adhesive from sticking to the rollers but also act as an interleaving film for the finished adhesive roll. In one aspect, one of the polymeric films can be replaced with a fabric or film to laminate the fabric or film on the adhesive layer to produce the carrier layer.

After the carrier layer is secured to the adhesive layer, it is ready to receive the painted image. In one aspect, the system is fed by a conveyor to a paint station. The paint station can be composed of a series of spray heads that spray paint on the carrier layer. The rate or pressure of the spray guns, screen print, roller or coater can determine the thickness as can the speed of the moving conveyor. Alternatively, the paint can be applied on a stationary platform. For images that require various colors such as disabled logos, warning signs, corporate logos, and the like, the paint can be applied by screen printing, airbrush spraying, stenciling, printed or other similar methods. In certain aspects when an anti-slip material is used, the anti-slip materials can be sprinkled over the wet system. After the paint has been applied, the system can be passed through a drying system and the resulting cured sheet is then rolled into suitable lengths for future slitting into widths for lines or sheets that are to be cut into shapes and legends.

The paint can be formulated to be fast drying. Typical paint compositions are water based, solvent based and polyurethane based. Water based paint is a non-flammable, lead-free, fast drying paint that is a available in all colors and is usually categorized by dry time and film thickness and are low VOC products. Solvent based paint comes in high and low viscosity chlorinated rubber, fast and regular dry alkylated, and regular and low VOC acrylic copolymer. These fast-drying paints are useful for highways, parking lots, crosswalks, stop bars, and legends. Polyurethane based paints are a homogeneous blend of polyurea resins and pigments and may contain reflective glass beads and anti-slip aggregates.

In certain aspects, the marking system can have a plurality of holes, where the holes penetrate the adhesive layer and carrier layer. Not wishing to be bound by theory, the holes permit any trapped air under the marking to escape when the marking is applied to the substrate. By doing this, the formation of air pockets or bubbles trapped between the marking and the substrate surface can be avoided. Air pockets can cause problems by either breaking the adhesive bond with the substrate or causing expansion due to elevated temperatures and possible delamination of the marking from the substrate surface. Over time, as pressure is applied to the laid marking (e.g, by continuous traffic), the small holes would be resealed by the adhesive.

The marking systems described herein are easy to apply to substrates that have an exposed surface. Examples of such substrates include, but are not limited to, a vehicular or pedestrian surface (i.e. a parking surface in a vehicle car park or road surface), pathway, corridor, hard standing area, footpath, as well as upright surfaces such as exposed faces of columns or walls. In general, the manufactured markings are taken to a site and laid down in the desired position. Chalk is used to mark around the system to set the position. In some circumstances, it may be desirable to apply a primer to the substrate surface to improve adhesion. In the case when the surface of the substrate is damp or wet, a thin layer of tetrachlorethylene, aromatic hydrocarbon, thermoplastic rubber, hydrocarbon resin or other suitable materials can be applied to the surface of the adhesive during the manufacture of the system. After the system has been applied to the substrate, pressure is applied to the system in order to ensure that the adhesive layer forms a good bond with the substrate surface. The use of rollers and related devices can be used herein. No other special equipment (e.g., torches or other heating devices) is needed to apply the system to the substrate.

Throughout this application, various publications are referenced. The disclosures of these publications in their entireties are hereby incorporated by reference into this application in order to more fully describe the compounds, compositions and methods described herein.

Various modifications and variations can be made to the compounds, compositions and methods described herein. Other aspects of the compounds, compositions and methods described herein will be apparent from consideration of the specification and practice of the compounds, compositions and methods disclosed herein. It is intended that the specification and examples be considered as exemplary.

What is claimed:

1. A flexible marking system that can be adhered to a substrate comprising:
(a) an adhesive layer comprising a first surface and a second surface;
(b) a carrier layer comprising a first surface and a second surface, wherein the first surface of the carrier layer is adjacent to the second surface of the adhesive layer, and the second surface of the carrier layer can receive one or more painted images; and
(c) at least one painted image on the second surface of the carrier layer.

2. The system of claim 1, wherein the adhesive layer comprises a pressure sensitive adhesive.

3. The system of claims 1 or 2, wherein the pressure sensitive adhesive comprises an acrylic.

4. The system in any of claims 1-3, wherein the adhesive layer comprises bitumen or modified bitumen.

5. The system in any of claims 1-4, wherein the adhesive layer comprises bitumen modified with SBS.

6. The system in any of claims 1-5, wherein the adhesive layer has a thickness less than or equal to 40 mils.

7. The system in any of claims 1-6, wherein the adhesive layer further comprises a reinforcing fiber incorporated in the adhesive layer.

8. The system of claim 7, wherein the reinforcing fiber comprises a polyester, a polyamide, a polyalkylene, a polyvinyl compound, or a glass fiber.

9. The system in any of claims 1-8, wherein a removable protective layer is adjacent to the first surface of the adhesive layer.

10. The system in any of claims 1-9, wherein the carrier layer comprises a woven material comprising a polyester, a polyamide, a polyalkylene, or a glass fiber.

11. The system in any of claims 1-10, wherein the carrier layer comprises a polymeric film.

12. The system in any of claims 1-11, wherein the second surface of the carrier layer comprises one or more anti-slip materials.

13. The system in any of claims 1-12, wherein the system comprises a plurality of holes.

14. The system in any of claims 1-13, wherein the painted image is derived from a water based paint, a solvent based paint, or a polyurethane based paint.

15. The system in any of claims 1-14, wherein the first surface of the adhesive layer comprises a layer comprising tetrachlorethylene, an aromatic hydrocarbon, a thermoplastic rubber, a hydrocarbon resin or any combination thereof.

16. A method for making the system in any of claims 1-15 comprising:
(a) applying a carrier layer having a first surface and second surface to an adhesive layer, wherein the adhesive layer is adjacent to the first surface of the carrier layer; and
(b) painting an image on the second surface of the carrier layer.

17. A method for applying the system in any of claims 1-15 to a substrate comprising (a) placing the system on the substrate, wherein the adhesive layer comes into contact with the substrate, and (b) applying sufficient pressure to the system so that the system is affixed to the substrate.
